(19) United States
(12) Patent Application Publication
(10) Pub. No.: US 2026/0133569 A1
(43) Pub. Date: May 14, 2026

(54) SEMICONDUCTOR PROCESS VARIABLE OPTIMIZATION METHOD BASED ON DIGITAL TWIN TECHNOLOGY

(71) Applicant: Samsung Electronics Co., Ltd., Suwon-si (KR)

(72) Inventors: Jaewoong Lee, Suwon-si (KR); Dayoung Ryu, Suwon-si (KR); Siho Song, Suwon-si (KR); Jiseong Doh, Suwon-si (KR); Jaehoon Jeong, Suwon-si (KR)

(21) Appl. No.: 19/282,123

(22) Filed: Jul. 28, 2025

(30) Foreign Application Priority Data
Nov. 14, 2024 (KR) 10-2024-0162256

(51) Int. Cl. G05B 19/418

(52) U.S. Cl. CPC G05B 19/41885; G05B 2219/35134; G05B 2219/45031

(57) ABSTRACT

A semiconductor process variable optimization method based on digital twin technology is provided. The method includes performing mirroring on each structure for each semiconductor product and each process step, performing process variable alignment of a simulation, for reproducing results of a first stress test for a simulation model obtained by performing the mirroring, and performing, with respect to an evaluation target of a second stress test evaluation different from the first stress test, process variable feedback of the simulation, wherein the first stress test and the second stress test differ in at least one of their respective process variables, the performing of the mirroring is performed in a semiconductor process variable optimization device, and the semiconductor process variable optimization device includes a first device and a second device.

### CROSS-REFERENCE TO RELATED APPLICATION(S)

This application is based on and claims priority under 35 U.S.C. § 119 to Korean Patent Application No. 10-2024-0162256, filed on Nov. 14, 2024, in the Korean Intellectual Property Office, the disclosure of which is incorporated by reference herein in its entirety.

### BACKGROUND

Torture evaluation is typically performed for inspection of structural defects occurring in a process set up for various semiconductor products. However, torture evaluation needs to be performed quickly to resolve defects, but also requires generating a new profile through a process that has not been used before, which frequently causes wafer consumption and is time-consuming. Accordingly, there is an increasing demand for evaluation methods that utilize technology to simulate semiconductor processes in a virtual space to overcome the cost and time limitations of wafer evaluation.

### SUMMARY

The present disclosure provides a semiconductor process variable optimization method based on digital twin technology, the method with improved reliability.

In addition, the objectives to be solved by the present disclosure are not limited to the above-mentioned ones, and other objectives could be clearly understood by those skilled in the art from the description below.

According to an aspect of the present disclosure, a semiconductor process variable optimization method is provided based on digital twin technology, the method including performing mirroring on each structure for each semiconductor product and each process step, performing process variable alignment of a simulation, for reproducing results of a first torture process for a simulation model obtained by performing the mirroring, and performing, with respect to an evaluation target of a second torture process evaluation different from the first torture process, process variable feedback of the simulation, wherein the first torture process and the second torture process differ in at least one of their respective process variables, the performing of the mirroring is performed in a semiconductor process variable optimization device, and the semiconductor process variable optimization device includes a first device and a second device.

According to another aspect of the present disclosure, a semiconductor process variable optimization method is provided based on digital twin technology, the method including performing mirroring on each structure for each semiconductor product and each process step, performing process variable alignment of a simulation, for reproducing results of a first torture process for a simulation model obtained by performing the mirroring, and performing, with respect to an evaluation target of a second torture process different from the first torture process, process variable feedback of the simulation, wherein the first torture process and the second torture process differ in at least one of their respective process variables, the performing of the mirroring includes selecting a product of development and mass production process stages, generating a virtual three-dimensional (3D) simulation model structure by one-to-one matching of each operation of the process sequence of the product, and selecting a structure for each process stage and performing mirroring on the selected structure.

According to another aspect of the present disclosure, a semiconductor process variable optimization method is provided based on digital twin technology, the method including performing mirroring on each structure for each semiconductor product and each process step, performing process variable alignment of a simulation, for reproducing results of a first torture process for a simulation model obtained by performing the mirroring, and performing, with respect to an evaluation target of a second torture process different from the first torture process, process variable feedback of the simulation, wherein the first torture process and the second torture process differ in at least one of their respective process variables, and each of the performing of the mirroring, the performing of the process variable alignment of the simulation, and the performing of the process variable feedback of the simulation is performed in a semiconductor process variable optimization device including a first device, a second device, a third device, and a fourth device, the performing of the mirroring includes selecting a product of development and mass production process stages, generating a virtual 3D simulation model structure by one-to-one matching of each operation of the process sequence of the product, and selecting a structure for each process stage and performing mirroring on the selected structure, the performing of the process variable alignment of the simulation further includes synchronizing the first condition of the first torture process with the first variable of the simulation, matching the simulation model to a transmission electron microscopy (TEM) image of the first torture process by adjusting a second variable that is different from the first variable among the process variables of the simulation, and updating values of the process variables of the simulation for which matching has been completed, in a database included in the first device, and the TEM image is captured by the second device and stored by the first device.

### BRIEF DESCRIPTION OF THE DRAWINGS

Implementations will be more clearly understood from the following detailed description taken in conjunction with the accompanying drawings in which:

FIG. 1 is a flowchart showing each operation of a semiconductor process variable optimization method based on digital twin technology, according to an implementation;

FIG. 2 is a flowchart showing detailed operations of an operation of performing mirroring included in a semiconductor process variable optimization method based on digital twin technology, according to an implementation;

FIG. 3 is a flowchart showing detailed operations of an operation of performing process variable alignment of a simulation included in a semiconductor process variable optimization method based on digital twin technology, according to an implementation;

FIG. 4 is a flowchart showing detailed operations of an operation of performing process variable feedback of a simulation included in a semiconductor process variable optimization method based on digital twin technology, according to an implementation;

FIG. 5 is a conceptual diagram illustrating how operation S210 of FIG. 3 is performed;

FIG. 6 is a conceptual diagram illustrating how operation S220 of FIG. 3 is performed;

FIG. 7 is a conceptual diagram illustrating operation S220 of FIG. 3 being performed, along with a transmission electron microscopy (TEM) image;

FIG. 8 is a conceptual diagram illustrating how operation S300 of FIG. 1 is performed;

FIG. 9 is a conceptual diagram illustrating operation S300 of FIG. 1 being performed, along with a TEM image; and

FIG. 10 is a conceptual diagram illustrating a semiconductor process variable optimization device according to an implementation.

### DETAILED DESCRIPTION

The present implementations may have various modifications and may take various forms, and some implementations are illustrated in the drawings and described in detail. However, this is not intended to limit the present implementations to a particular disclosure form. In addition, the implementations described below are merely examples, and various modifications are possible from these implementations.

The use of any and all examples, or exemplary language provided herein, is intended merely to better illuminate the present disclosure and does not pose a limitation on the scope of the present disclosure unless otherwise claimed.

Unless otherwise specifically stated, in the present specification, a vertical direction is defined as a Z direction, and a first horizontal direction and a second horizontal direction may each be defined as a horizontal direction perpendicular to the Z direction. The first horizontal direction may be referred to as an X direction, and the second horizontal direction may be referred to as a Y direction. A vertical level may refer to the height level along the vertical direction (Z direction). A horizontal width in the first horizontal direction may refer to a length in the horizontal direction (X direction and/or Y direction), and a vertical length may refer to a length in the vertical direction (Z direction).

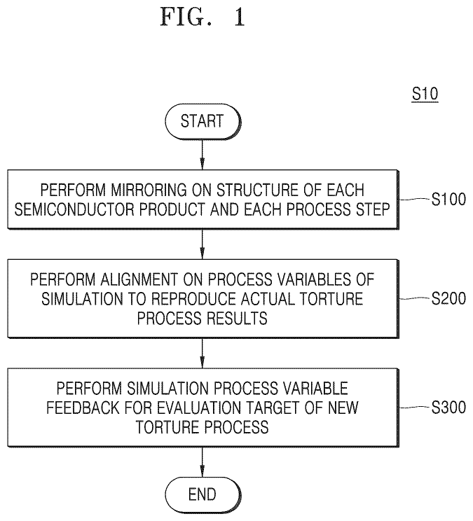

FIG. 1 is a flowchart showing each operation of a semiconductor process variable optimization method based on digital twin technology, according to an implementation.

Referring to FIG. 1, the semiconductor process variable optimization method according to the present disclosure may be based on digital twin technology. A digital twin is technology in which a digital replica model of a physical object, system, or semiconductor process is generated to reflect and simulate data processed in a real environment in real time. In an implementation, a digital twin is a model for a torture process performed when setting up a new semiconductor process line. In an implementation, for a digital twin, technologies of cloud computing, artificial intelligence, and machine learning algorithms may be utilized together.

In an implementation, a semiconductor process variable optimization method S10 based on digital twin technology targets a torture process model, as described above. The torture process according to an implementation is a test process in which the durability and reliability of semiconductor products are verified by exposing wafers or devices to extreme environmental conditions. In addition, the torture process according to an implementation may be a method of detecting and visualizing a defect by inducing a defect so as to easily detect a defective signal that is not clearly visible to the naked eye. The torture process may focus on measuring performance under extreme conditions such as high temperature, low temperature, high voltage, and mechanical stress, thereby ensuring long-term reliability.

In an implementation, the semiconductor process variable optimization method S10 based on digital twin technology, according to an implementation, may include operation S100 of performing mirroring on a structure of each semiconductor product and each process step. Semiconductor products in operation S100 may include products at the device stage as well as the package stage.

In operation S100, a “process” among process steps may include a development process and a mass production process for a semiconductor product, and a “step” may refer to an operation of forming each structure of a semiconductor product. In an implementation, each step may include an operation of forming a fin in a fin field-effect transistor (finFET) structure, an operation of forming a polysilicon contact, an operation of forming a source and a drain, an operation of forming a replacement metal gate, an operation performed in a middle of line (MOL) between a front-end-of-line (FEOL) process and a back-end-of-line (BEOL) process, and a BEOL process of forming a metal wiring layer to complete electrical connection between devices.

Mirroring in operation S100 is a term used in digital twin technology, and refers to an operation in which the actual appearance implemented in each semiconductor product and process step described above is formed into a three-dimensional (3D) shape simulation model.

In an implementation, the semiconductor process variable optimization method S10 based on digital twin technology may include operation S200 of performing alignment on process variables of a simulation obtained through mirroring in operation S100 to reproduce actual torture process results. The actual torture process in operation S200 may be referred to as a first torture process. A second torture process, which is different from the first torture process and is to be described below, may be a process for new torture evaluation in contrast to an actual process. The torture process can also be referred to as a stress test in the present disclosure.

The process variables in the simulation may be of the same type as the process variables used in an actual torture process. Therefore, the process variables of the simulation may be adjusted to correspond to values of process variables used in the first torture process, which is an actual torture process. That is, the values of each simulation process variable may be aligned to be identical to those of the process variable of the first torture process.

In an implementation, the semiconductor process variable optimization method S10 based on digital twin technology may include operation S300 of performing simulation process variable feedback for an evaluation target (e.g., semiconductor product, structure of each process used for mass production of a product) of a new torture process that is different from the actual torture process in operation S200. The new torture process may correspond to the second torture process. The first torture process and the second torture process may have some same process variables, but other process variables may be different. In an implementation, the first torture process and the second torture process may be performed at different times. In the present disclosure, the new torture process is referred to as the second torture process, but the new torture process may be not only the second torture process, but also a third or fourth torture process or more.

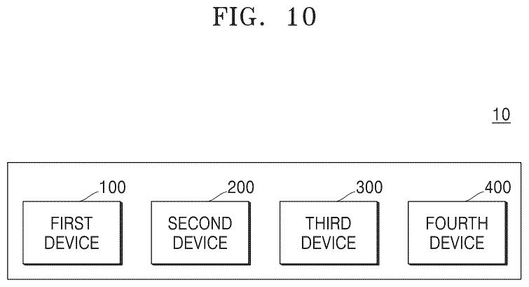

The semiconductor process variable optimization method S10 based on digital twin technology may be performed by a semiconductor process variable optimization device (10 of FIG. 10). The semiconductor process variable optimization device (10 of FIG. 10) may include a first device (100 of FIG. 10), a second device (200 of FIG. 10), a third device (300 of FIG. 10), and a fourth device (400 of FIG. 10). In the present disclosure, the first device can be referred to as a first component device, the second device as a second component device, the third device as a third component device, and the fourth device as a fourth component device.

The first device (100 of FIG. 10) may be configured to provide a space for storing data. The second device (200 of FIG. 10) may be configured to capture an image. The third device (300 of FIG. 10) may be configured to process image generation and processing, and data matching. In an implementation, the third device (300 of FIG. 10) may include a processor for performing machine learning or deep learning. The fourth device (400 of FIG. 10) may be configured to comprehensively control the first to third devices of the semiconductor process variable optimization device (10 of FIG. 10).

A detailed explanation thereof is provided with reference to FIG. 10.

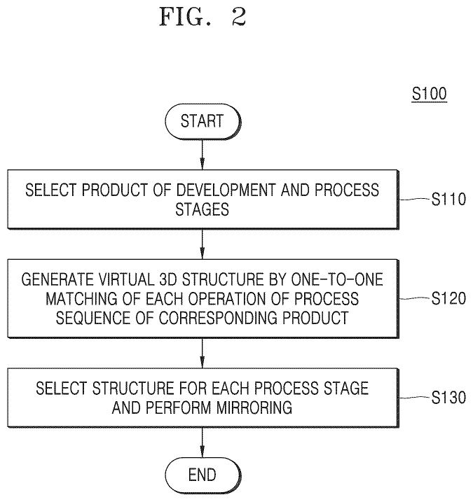

FIG. 2 is a flowchart showing detailed operations of an operation of performing mirroring included in a semiconductor process variable optimization method based on digital twin technology, according to an implementation.

Referring to FIG. 2 together with FIG. 1, operation S100 of performing mirroring may include operation S110 of selecting a product of the development and process stages. The process stage in operation S110 may refer to the mass production stage.

A product in operation S110 may refer to a semiconductor product, and even the device level, the package level, and the finished product level. In other words, it may be understood as an operation of selecting semiconductor products in the development stage or mass production stage. Operation S110 may be performed in the fourth device (400 of FIG. 10) included in the semiconductor process variable optimization device (10 of FIG. 10). Information about a product selected in operation S110 may be stored in the first device (100 of FIG. 10) included in the semiconductor process variable optimization device (10 of FIG. 10).

Operation S100 of performing mirroring may include operation S120 of generating a virtual 3D structure by one-to-one matching of each operation of the process sequence of a corresponding product selected in operation S110. The virtual 3D structure in operation S120 may be a simulation structure. Operation S120 may be performed in the third device (300 of FIG. 10) included in the semiconductor process variable optimization device (10 of FIG. 10). The 3D structure simulation model generated in operation S120 may be stored in the first device (100 of FIG. 10) included in the semiconductor process variable optimization device (10 of FIG. 10).

The process stages or steps in operation S120 may include a photolithography operation, an etching operation, a deposition operation, an ion implantation operation, and a metal interconnect operation.

As an implementation, in the case of a photolithography operation, data of the lithography operation, such as the uniform thickness of the photoresist, exposure conditions, and resolution, may be collected in real time and mirrored in a simulation model. Afterwards, by applying and feeding back each process variable to the simulation model in operation S200 and operation S300, the exposure conditions may be optimized, pattern defects may be reduced, and the resolution may be further improved.

In an implementation, for the etch and deposition operations, data on process depth and pattern formation may be collected, and it may be verified that the etch depth or deposition thickness meets the design conditions. In this operation, uniform etching and deposition rate may be ensured and defects may be reduced.

The characteristics of the patterns may be summarized into several items as follows. For example, the characteristics of each pattern may be quantified and extracted, such as tone, direction, length, density, sublayer, width and space of neighboring segments in the normal direction, information about the next/previous segment, and harmonics.

As an implementation, for the ion implantation operation, data on the type, energy, and angle of ions implanted into the wafer may be collected and modeled. This allows verification of the specifications for the doping profile of the wafer and the final device characteristics.

As an implementation, in the case of the metal wiring operation, the thickness of metal layers connecting circuits, the resistance value, the shape of the metal layer, etc. may be monitored and collected in real time, and a simulation model may be implemented.

Operation S100 of performing mirroring may include operation S130 of selecting a structure for each process stage among the structures generated in operation S120 and performing mirroring on the structure in the process of the corresponding operation. Operation S130 may be performed in the third device (300 of FIG. 10) included in the semiconductor process variable optimization device (10 of FIG. 10).

In FIG. 2, operations S120 and S130 are shown separately, showing that operation S130 is performed sequentially after operation S120. However, depending on the type of semiconductor product and process, operations S120 and S130 may be performed simultaneously.

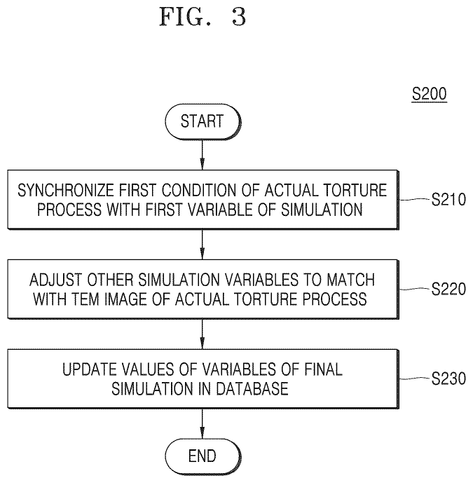

FIG. 3 is a flowchart showing detailed operations of an operation of performing process variable alignment of a simulation included in a semiconductor process variable optimization method based on digital twin technology, according to an implementation.

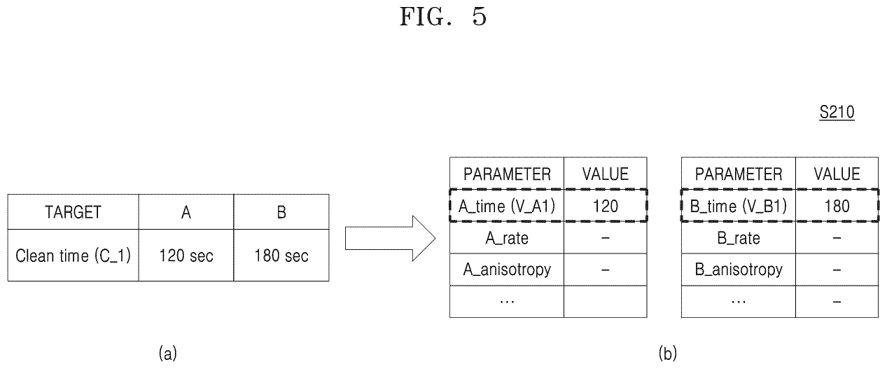

FIG. 3 will be referred to together with FIGS. 1 and 2. Operation S200 of performing process variable alignment of a simulation may include operation S210 of synchronizing a first condition (C_1 in FIG. 5) among a plurality of process conditions of the first torture process, which is an actual torture process, and first variables (V_A1, V_B1 in FIG. 5) among a plurality of variables of the simulation.

The first condition (C_1 in FIG. 5) may be one of the process variables. That is, the process variables may be a concept that includes conditions of the first torture process or variables of simulation. As an implementation, the first condition (C_1 in FIG. 5) and the first variables (V_A1, V_B1 in FIG. 5) may be a process progress time. Operation S210 may be performed in the fourth device (400 of FIG. 10) included in the semiconductor process variable optimization device (10 of FIG. 10).

In operation S210, synchronization may correspond to matching the values of the first condition of the first torture process (C_1 in FIG. 5) to the first variables of the simulation (V_A1, V_B1 in FIG. 5). As an implementation, if the value of the first condition (C_1 in FIG. 5) of the first torture process is 120 seconds for A and 180 seconds for B, the value of V_A1 among the first variables of the simulation may be set to 120 seconds and the value of V_B1 among the first variables may be set to 180 seconds.

Operation S200 of performing process variable alignment of the simulation may include operation S220 of adjusting the other simulation variables than the variables synchronized in operation S210 to match them with a transmission electron microscopy (TEM) image of the first torture process. The remaining simulation variables in operation S220 may be referred to as a second variable. Except for the first variables, the remaining simulation variables may be multiple. If there are multiple remaining simulation variables, they may be referred to as a third variable as well as the second variable. In an implementation, the second variable may be an etching rate when the first torture process is an etching process. In an implementation, the variables including the first variable and the second variable may include materials, time, ratio, and anisotropy of each process step for each semiconductor product. Operation S220 may be performed in the fourth device (400 of FIG. 10) included in the semiconductor process variable optimization device (10 of FIG. 10).

The TEM image of the first torture process to be matched in S220 may be an image captured by the second device (200 of FIG. 10) included in the semiconductor process variable optimization device (10 of FIG. 10) and already stored in the first device (100 of FIG. 10) included in the semiconductor process variable optimization device (10 of FIG. 10).

The aim of operation S220 is to secure simulation variables that may generate a structure identical to the structure of the final product of the first torture process by adjusting the second variable. Therefore, operation S220 may be performed repeatedly to continuously compare the TEM image of the first torture process with the simulation image until the two images become identical.

Operation S200 of performing process variable alignment of the simulation may further include operation S230 of updating, in a database, the values of the process variables of the simulation, for which matching has been completed in operation S220. The database may include the first device (100 of FIG. 10) that includes the semiconductor process variable optimization device (10 of FIG. 10). Operation S230 may be performed in the third device (300 of FIG. 10) included in the semiconductor process variable optimization device (10 of FIG. 10).

Final simulation variable values of operation S230 may include the first variable and the second variable. The values of the simulation variables updated in operation S230 may be used in operation S300.

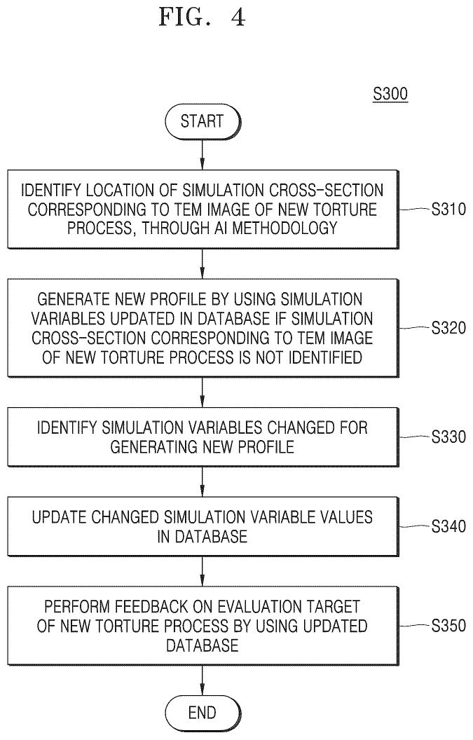

FIG. 4 is a flowchart showing detailed operations of an operation of performing process variable feedback of a simulation included in a semiconductor process variable optimization method based on digital twin technology, according to an implementation.

FIG. 4 will be referred to together with FIGS. 1 to 3. Operation S300 of performing process variable feedback of the simulation may include operation S310, which is an operation of identifying the location of a cross-section of the simulation corresponding to a TEM image of the second torture process, which is a new torture process. Operation S310 is where artificial intelligence (AI) methodology may be utilized.

The AI methodology utilized in operation S310 refers to the one used to precisely synchronize data between the actual torture process environment and the virtual digital simulation model. In the AI methodology, accurate matching may be performed mainly through deep learning-based technologies such as image recognition, feature matching, object detection, and location alignment.

In other words, the AI methodology may include methods of automatically matching digital representations of physical objects to real-world data by utilizing machine learning and deep learning to perform image matching tasks in systems such as the digital twin of the present disclosure. In an implementation, the AI methodology of the present disclosure may include data pattern recognition, prediction, alignment, and optimization. In the case of deep learning-based image recognition, as an implementation, features may be extracted from images using models such as convolutional neural networks (CNNs). In addition, during the matching process, the pattern and structure of each image are analyzed, and the deep learning model learns the complex features of various images, and may perform accurate matching between the images of the first and second torture processes, which are images of the real environment, and the images of the simulation model, which is a virtual environment. Operation S310 may be performed in the fourth device (400 of FIG. 10) included in the semiconductor process variable optimization device (10 of FIG. 10).

Operation S300 of performing process variable feedback of the simulation may include operation S320 of generating a new profile using the simulation variables updated in the database if a simulation cross-section corresponding to a TEM image of the second torture process is not identified in operation S310. If the simulation cross-section corresponding to the TEM image of the second torture process is identified in operation S320, operations S330 and S340 of FIG. 4 may be omitted and operation S350 may be performed.

Operation S320 may be performed in the third device (300 of FIG. 10) included in the semiconductor process variable optimization device (10 of FIG. 10). Operation S320 may be repeatedly performed (e.g., like operation S220) to modify at least one process variables that are previously obtained based on the first torture process, until both the TEM image of the second torture process and the new profile image become identical to each other. Therefore, the new profile may be generated based on (i) the modified process variables (e.g., operation S320) and (ii) other unmodified process variables (e.g., the first and second variables) that are previously obtained based on the first torture process (e.g., operation S220).

Operation S300 of performing process variable feedback of the simulation may include operation S330 of identifying simulation process variables of the new profile generated in operation S320 (e.g., the process variables that are modified in the operation S320). Operation S330 may be performed in the third device (300 of FIG. 10) included in the semiconductor process variable optimization device (10 of FIG. 10). In operation S330, verification on variables other than the first variable, including the second variable may be performed. Operation S300 may include operation S340 of updating a database with respect to the changed simulation process variable values identified in operation S330. Operation S340 may be performed in the third device (300 of FIG. 10) included in the semiconductor process variable optimization device (10 of FIG. 10) and ultimately stored in the first device (100 of FIG. 10).

Operation S300 of performing process variable feedback of the simulation may include operation S350 of performing feedback using the database updated in operation S340 on a target of the second torture process evaluation. The feedback in operation S350 refers to reflecting simulation variables in the first torture process and the second torture process, which are actual processes (for example, thereby adjusting actual fabrication steps to achieve a desired target), or when operations S100, S200, and S300 are performed for different processes of different semiconductor products.

FIG. 5 is a conceptual diagram illustrating how operation S210 of FIG. 3 is performed.

Referring to FIG. 5 together with FIGS. 1 to 4, Table (a) of FIG. 5 illustrates information about a target during the first torture process. As an implementation, the target of the first torture process may be clean time. The clean time may correspond to a first condition C_1 of operation S210. Referring to Table (a) of FIG. 5, it may be confirmed that the clean time is 120 seconds for A, and the clean time is 180 seconds for B. Since A and B are different semiconductor products, their clean times may also be formed differently.

Table (b) in FIG. 5 shows information about parameters and values of the simulation process. The table located on the left in Table (b) may correspond to case A in Table (a). The table located on the right side of Table (b) may correspond to case B of Table (a). Among multiple parameters, the variables corresponding to the first condition C_1 may be the first variable. As an implementation, the first variable of the table located on the left side of table (b) may be V_A1. As an implementation, the first variable of the table located on the right side of table (b) may be V_B1. That is, the first variable may be referred to or have different values depending on the product.

Among the first variables, V_A1 may be aligned to 120 seconds to correspond to product A among the first condition C_1. Among the first variables, V_B1 may be aligned to 180 seconds to correspond to product B among the first condition C_1. That is, each of V_A1 and V_B1 may be adjusted to match each case of C_1 at operation S210.

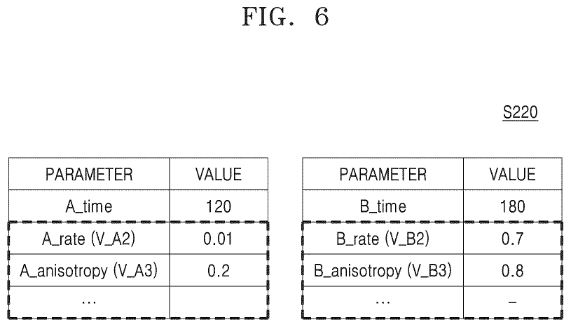

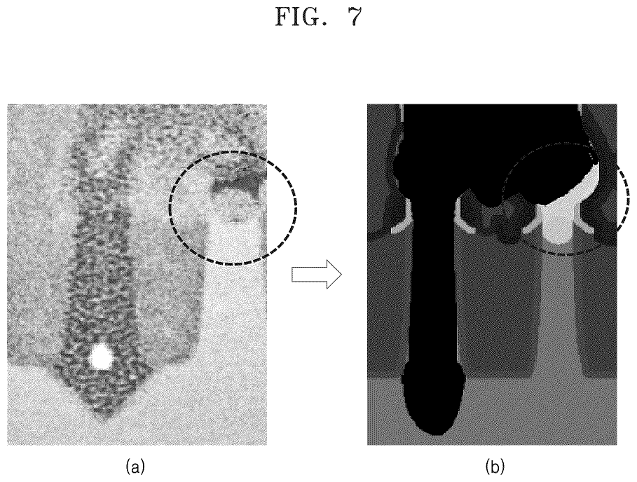

FIG. 6 is a conceptual diagram illustrating how operation S220 of FIG. 3 is performed. FIG. 7 is a conceptual diagram illustrating operation S220 of FIG. 3 being performed, along with a TEM image.

Referring to FIG. 6 together with FIGS. 1 to 5, the table located on the left side of the table in FIG. 6 may correspond to case A of table (a) of FIG. 5. The table located on the right side of the table in FIG. 6 may correspond to case B of table (a) in FIG. 5. Variables other than the first variable may be adjusted in operation S220. If there are multiple variables other than the first variable as in FIG. 6, they may be named as the second variable and the third variable. As an implementation, for A, V_A2 may be included as a second variable, and V_A3 may be included as a third variable. As an implementation, for A, the second variable V_A2 may be a rate at which the process is progressing.

In the case of etching, the second variable V_A2 may be an etching rate, and in the case of deposition, the second variable V_A2 may be a deposition rate, which indicates the amount of deposition per hour. As an implementation, for A, the third variable V_A3 may represent a value for anisotropy. The above also applies to case B. As an implementation, for B, V_B2 may be included as a second variable and V_B3 may be included as a third variable. As an implementation, for B, the second variable V_B2 may include a rate at which the process progresses, such as an etching rate in the case of etching, or a deposition rate representing the amount of deposition per hour in the case of deposition. As an implementation, for B, the third variable V_B3 may represent a value for anisotropy.

Each case represents a different product, and even if the number of each variable is the same, each variable for each product may have different values. As an implementation, the second variable V_A2 of case A may have a ratio of 0.01. On the other hand, in case of B, the second variable V_B2 may have a different value from that of case A, with a ratio of 0.7.

As an implementation, the third variable V_A3 of case A may have an anisotropy of 0.2. On the other hand, in case of B, the third variable V_B3 may have a different value from case A, with an anisotropy of 0.8.

The second and third variables may not have matching values in the first torture process. That is, after only the first variable is matched in the simulation, the simulation process is performed by adjusting the second and third variables, and process result values corresponding to various process parameters may be obtained through the simulation.

Referring to FIG. 7, the remaining variables including the second variable and the third variable may be adjusted until a simulation result (b) matching (a) which is a TEM image as in FIG. 7 is obtained. Therefore, operation S220 may be performed repeatedly.

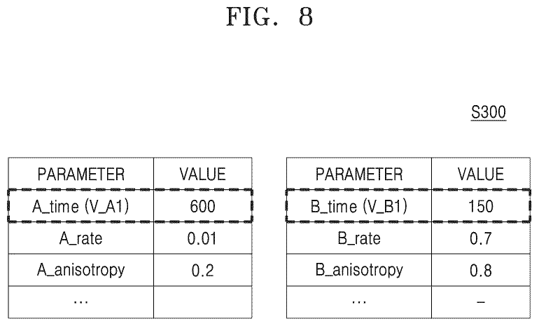

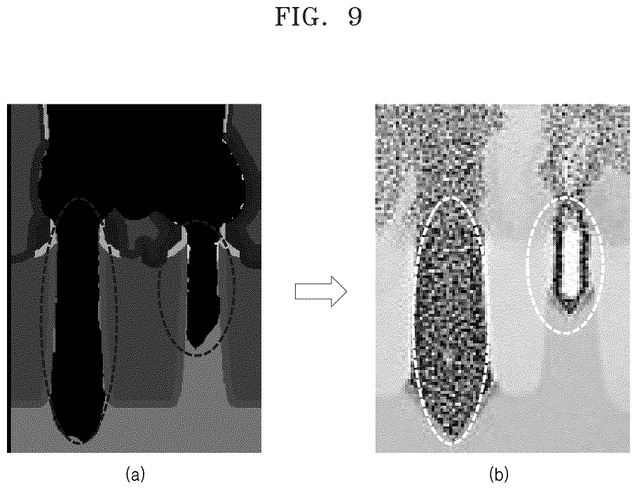

FIG. 8 is a conceptual diagram illustrating how operation S300 of FIG. 1 is performed. FIG. 9 is a conceptual diagram illustrating operation S300 of FIG. 1 being performed, along with a TEM image.

Referring to FIG. 8 together with FIGS. 1 to 7, the process variables of the simulation may be fed back to match the target of the second torture process evaluation. As an implementation, in FIG. 8, it may be confirmed that feedback was performed for the first variables in both cases A and B.

As an implementation, in case of A, it may be confirmed that the first variable V_A1 has been changed to 600 seconds. As an implementation, in case of B, it may be confirmed that the first variable V_B1 has been changed to 150 seconds. It may be confirmed that the values of the second and third variables of A are the same as those in FIG. 6. Additionally, in the case of B, it may be confirmed that the values of the second and third variables are the same as those in FIG. 6. In FIG. 7, the variables were adjusted such that (a) which is a TEM image of the first torture process corresponds to (b) which is a simulation cross-section.

Referring to FIG. 9, it may be compared whether the cross-section (a) that was simulated by adjusting the first variable as in FIG. 8 in the second process, which is a new torture process, corresponds to (b), which is a TEM image of the actual second torture process. That is, in FIGS. 6 and 7, the simulation is repeated based on the TEM image, and the variable values corresponding to the TEM image are found and updated, whereas, in contrast, in FIGS. 8 and 9, a new profile is configured for a new torture process, the second torture process, and when the variables corresponding to the new profile are substituted into the actual process conditions, verification is performed through the TEM image.

FIG. 10 is a conceptual diagram illustrating a semiconductor process variable optimization device according to an implementation.

Referring to FIG. 10, a semiconductor process variable optimization device 10 may include a first device 100, a second device 200, a third device 300, and a fourth device 400. The semiconductor process variable optimization method (S10 of FIG. 1) based on digital twin technology may be performed by the semiconductor process variable optimization device 10, but this is only an example form, and the semiconductor process variable optimization method (S10 of FIG. 1) may be performed by a plurality of devices including the first to fourth devices 100, 200, 300, and 400 or more.

The first device 100 may include a memory. The memory may store an image file. The memory may store a first image file and/or a second image file. The memory may include at least one of volatile memory or nonvolatile memory. Nonvolatile memory includes read only memory (ROM), programmable ROM (PROM), electrically programmable ROM (EPROM), electrically erasable and programmable ROM (EEPROM), and flash memory. Volatile memory may include dynamic random-access memory (DRAM), static RAM (SRAM), synchronous DRAM (SDRAM), phase-change RAM (PRAM), magnetic RAM (MRAM), resistive RAM (RRAM), ferroelectric RAM (FeRAM), etc. In an implementation, the memory may include at least one of a hard disk drive (HDD), a solid-state drive (SSD), a compact flash (CF) card, a secure digital (SD) card, a micro secure digital (Micro-SD) card, a mini secure digital (Mini-SD) card, an extreme digital (xD) card, or a memory stick.

The second device 200 may include a camera module for obtaining TEM images. The camera module may include a lens array, an aperture, mirrors for changing the light path, etc. The second device 200 may inspect a wafer and generate multiple image files. The second device 200 may inspect a substrate in a destructive and/or non-destructive manner. For example, the second device 200 may inspect a substrate in a scanning manner. For example, although the second device 200 in the present disclosure is described based on a TEM, the second device 200 may include a scanning electron microscope (SEM), an automatic optical inspection (AOI) device, and/or an atomic force microscope (AFM).

The third device 300 may include a machine learning processor to perform simulation image generation and matching, etc. A machine learning processor may train (or learn) a machine model or infer information contained in input data by analyzing the input data using a machine learning model. Machine learning processors may make judgments about situations or control components of electronic devices based on inferred information.

Additionally, the machine learning processor may receive input data from memory and generate output data based on the received input data. The machine learning processor may train and/or operate a machine learning model based on the overlapping image files. The machine learning processor may form a simulation model that matches the cross-section of a new torture process based on the overlapping image files.

The machine learning processor may be implemented as neural network computation accelerators, coprocessors, digital signal processors (DSPs), application specific integrated circuits (ASICs), field-programmable gate arrays (FPGAs), graphics processing units (GPUs), neural processing units (NPUs), tensor processing units (TPUs), and multi-processor system-on-chips (MPSoCs).

The machine learning processor may perform machine learning models such as K-means clustering, hierarchical clustering, density-based spatial clustering of applications with noise (DBSCAN), mean shift, and/or agglomerative clustering.

In another implementation, the machine learning processor may execute a neural network model based on an artificial neural network (ANN), a convolution neural network (CNN), a region with convolution neural network (R-CNN), a region proposal network (RPN), a recurrent neural network (RNN), a generative adversarial network (GAN), a self-attention generative adversarial network (SAGAN), a stacking-based deep neural network (S-DNN), a state-space dynamic neural network (S-SDNN), a deconvolution network, a deep belief network (DBN), a restricted Boltzmann machine (RBM), a long short-term memory (LSTM) network, a classification network, a plain residual network, a dense network, a hierarchical pyramid network, a transformer network and/or a vision transformer network.

The fourth device 400 may include a central processing unit (CPU) that comprehensively controls the remaining components of the semiconductor process variable optimization device 10. The CPU may control the overall operation of the semiconductor process variable optimization device 10. The CPU may include one processor core (single core) or multiple processor cores (multi-core). The CPU may process or execute programs and/or data stored in storage areas such as memory using RAM.

The CPU may overlap multiple image files generated in the semiconductor process variable optimization device 10. The CPU may overlap multiple image files stored in the memory. In another implementation, the machine learning processor may overlap multiple image files.

The above-described implementations are merely examples, and those skilled in the art will appreciate that various modifications and equivalent other implementations may be made from the above-described examples. Therefore, the true scope of technical protection according to the implementations should be defined by the technical idea described in the following patent claims.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A semiconductor process variable optimization method based on digital twin technology, the method comprising:
performing, using at least one processor, a mirroring operation on one or more structures of one or more semiconductor products at one or more process steps to generate a virtual three-dimensional (3D) model that mirrors the one or more structures;
performing, using the at least one processor, a process variable alignment operation in a simulation to determine at least one process variable of the simulation by matching a result of the simulation with data of a first stress test; and
performing, using the at least one processor, a process variable feedback operation for an evaluation target of a second stress test different from the first stress test, the first stress test and the second stress test having at least one different process variable.

2. The method of claim 1, wherein, based on digital twin technology, performing the mirroring operation comprises:
selecting a product from the one or more semiconductor products; and
generating the virtual 3D model by matching each process step of the one or more process steps of the selected product.

3. The method of claim 1, wherein, based on digital twin technology, performing the mirroring operation comprises:
selecting a structure for each of the one or more process steps and performing mirroring on the selected structure.

4. The method of claim 1, wherein, based on digital twin technology, performing the process variable alignment operation in the simulation comprises:
synchronizing a first condition of the first stress test with a first variable of the at least one process variable of the simulation.

5. The method of claim 4, wherein, based on digital twin technology, the data of the first stress test comprises a first transmission electron microscopy (TEM) image, and
wherein performing the process variable alignment operation in the simulation comprises:
matching the result of the simulation to the first TEM image of the first stress test by adjusting a second variable of the at least one process variable of the simulation, the second variable being different from the first variable.

6. The method of claim 5, wherein the at least one processor is included in a device, and wherein the device comprises:
a first component device configured to store the first TEM image, and
a second component device configured to capture the first TEM image.

7. The method of claim 5, wherein, based on digital twin technology, performing the process variable alignment operation in the simulation comprises:
updating, in a database, a value of the at least one process variable of the simulation based on the matching.

8. The method of claim 7, wherein, based on digital twin technology, performing the process variable feedback operation comprises:
identifying a location of a cross-section of the virtual 3D model that corresponds to a second TEM image of the second stress test; or
based on a failure to identify the location of the cross-section of the virtual 3D model that corresponds to the second TEM image of the second stress test, (i) generating a new profile that corresponds to the second TEM image by modifying one or more process variables of the at least one process variable that is associated with the first stress test and stored in the database, and (ii) identifying the one or more modified process variables associated with the new profile.

9. The method of claim 8, wherein, based on digital twin technology, performing the process variable feedback operation comprises:
updating, in the database, one or more values of the one or more modified process variables; and
performing, using the updated database, feedback for the evaluation target of the second stress test.

10. The method of claim 1, wherein, based on digital twin technology, the at least one process variable comprises at least one of a material, time, ratio, or anisotropy of the one or more semiconductor products at the one or more process steps.

11. A semiconductor process variable optimization method based on digital twin technology, the method comprising:
performing, using at least one processor, a mirroring operation on one or more structures of one or more semiconductor products at one or more process steps to generate a virtual three-dimensional (3D) model that mirrors the one or more structures;
performing, using the at least one processor, a process variable alignment operation in a simulation to determine at least one process variable of the simulation by matching a result of the simulation with data of a first stress test; and
performing, using the at least one processor, a process variable feedback operation on an evaluation target of a second stress test that is different from the first stress test, the first stress test and the second stress test having at least one different process variable,
wherein performing the mirroring operation comprises:
selecting a product from the one or more semiconductor products,
generating the virtual 3D model by matching each process step of the one or more process steps of the selected product, and
selecting a structure of the virtual 3D model at each process step, and performing mirroring on the selected structure at each process step.

12. The method of claim 11, wherein, the at least one processor is included in a device, and wherein the device comprises a first component device that includes a memory, a second component device that includes a camera, a third component device that includes the at least one processor, and a fourth component device configured to control operations of the first to third component devices.

13. The method of claim 12, wherein, based on digital twin technology, performing the process variable alignment operation comprises:
synchronizing a first condition of the first stress test with a first variable of the at least one process variable of the simulation; and
matching the result of the simulation to a first transmission electron microscopy (TEM) image of the first stress test by adjusting a second variable of the at least one process variable of the simulation, the second variable being different from the first variable.

14. The method of claim 13, wherein, based on digital twin technology, performing the process variable alignment operation comprises:
updating, in a database stored in the first component device, at least one value of the at least one process variable of the simulation based on the matching,
wherein the first component device is configured to store the first TEM image, and the second component device is configured to capture the first TEM image.

15. The method of claim 14, wherein, based on digital twin technology, performing the process variable feedback operation comprises:
identifying a location of a cross-section of the virtual 3D model that corresponds to the TEM image of the second stress test;
based on a failure to identify the location of the cross-section of the virtual 3D model that corresponds to a second TEM image of the second stress test, generating a new profile that corresponds to the second TEM image by modifying one or more process variables of the at least one process variable that is associated with the first stress test and stored in the database;
identifying the one or more modified process variables associated with the new profile; and
updating, in the database, one or more values of the one or more modified process variables.

16. The method of claim 15, wherein, based on digital twin technology, performing the process variable feedback operation comprises:
performing, using an updated database, feedback for the evaluation target of the second stress test.

17. The method of claim 11, wherein, based on digital twin technology, the at least one process variable comprises at least one of a material, time, ratio, or anisotropy of the one or more semiconductor products at the one or more process steps.

18. A semiconductor process variable optimization method based on digital twin technology, the method comprising:
performing, using at least one processor, a mirroring operation on one or more structures of one or more semiconductor products at one or more process steps to generate a virtual three-dimensional (3D) model that mirrors the one or more structures;
performing, using the at least one processor, a process variable alignment operation in a simulation to determine at least one process variable of the simulation by matching a result of the simulation with data of a first stress test; and
performing, using the at least one processor, a process variable feedback operation for an evaluation target of a second stress test that is different from the first stress test, the first stress test and the second stress test having at least one different process variable,
wherein the at least one processor is included in a device, the device comprises a first component device configured to store a first transmission electron microscopy (TEM) image of the first stress test and a second component device configured to capture the first TEM image,
wherein performing the mirroring operation comprises:
selecting a product from the one or more semiconductor products,
generating the virtual 3D model by matching each process step of the one or more process steps of the selected product, and
selecting a structure from the virtual 3D model at each process step, and performing mirroring on the selected structure at each process step, and
wherein performing the process variable alignment operation comprises:
synchronizing a first condition of the first stress test with a first variable of the at least one process variable of the simulation,
matching the result of the simulation to the first TEM image by adjusting a second variable of the at least one process variable of the simulation, the second variable being different from the first variable, and
updating, in a database stored in the first component device, at least one value of the at least one process variable of the simulation based on the matching.

19. The method of claim 18, wherein, based on digital twin technology, performing the process variable feedback operation comprises:
identifying a location of a cross-section of the virtual 3D model that corresponds to a second TEM image of the second stress test; or
based on a failure to identify the location of the cross-section of the virtual 3D model that corresponds to the second TEM image,
generating a new profile that corresponds to the second TEM image by modifying one or more process variables of the at least one process variable that is associated with the first stress test and stored in the database,
identifying the one or more modified process variables associated with the new profile,
updating, in the database, one or more values of the one or more modified process variables, and
performing, using the updated database, feedback for the evaluation target of the second stress test.

20. The method of claim 18, wherein, based on digital twin technology, the at least one process variable comprises at least one of a material, time, ratio, or anisotropy of the one or more semiconductor products at the one or more process steps.
